(19) United States
(12) Patent Application Publication
(10) Pub. No.: US 2022/0104146 A1
(43) Pub. Date: Mar. 31, 2022

(54) COORDINATED POWER CONTROL USING A POWER CONSERVATION MODE

(71) Applicant: ARRIS Enterprises LLC, Suwanee, GA (US)

(72) Inventors: Krishna Prasad PANJE, Bengaluru (IN); Lakshmi ARUNKUMAR, Bangalore (IN)

(21) Appl. No.: 17/480,732

(22) Filed: Sep. 21, 2021

Related U.S. Application Data
(60) Provisional application No. 63/084,105, filed on Sep. 28, 2020.

(51) Int. Cl. H04W 52/24; H04W 84/18; H04W 52/02; H04B 17/318

(52) U.S. Cl. CPC H04W 52/245; H04B 17/318; H04W 52/0206; H04W 84/18

(57) ABSTRACT

A network controller device initiates coordinated power control for a mesh network and implement a power conservation mode using the coordinated power control. A performance characteristic. such as received signal strength indicator (RSSI) and throughput, associated with a network device in the mesh network is measured. A power output of the network device is lowered until the performance characteristic associated with the network device is at a selected minimum performance threshold.

### BACKGROUND

The subject matter of the present disclosure relates generally to provide adequate coverage and quality of service with the least possible power radiation.

Network devices have multiple radios and provide multiple SSIDs for each radio. These are generally set at default high power so that users get best coverage. This results in inefficient network utilization because of reluctance of a client to move to provide load balancing, creates congested network environments, and wastes energy.

### SUMMARY

An aspect of the present disclosure involves managing energy usage by devices in a network.

Coordinated power control is implemented in a mesh network that uses a power conservation mode. A performance characteristic, such as received signal strength indicator (RSSI) and throughput, may be used to minimize power usage and energy radiation in a network. The performance characteristic is measured and maintained as a client device roams the network and disengages the connection from one network access device and establishes a connection with another network access device. A backhaul RSSI and throughput may also be measured for a network access device.

Power output is adjusted until the performance characteristic associated with a network access device is at a selected minimum performance threshold. When a network access device, such as an access point or an extender is initialized, a default maximum power output setting is used. When the network access device has been configured to operate in the power conservation mode, the power conservation mode may be implemented to minimize power usage. Power output levels may be restored to the default maximum power output setting. A backhaul power output at a network access device may be controlled by a gateway and power output measured at a client device may be controlled. The power level of a gateway and of a network access device, such as an access point or an extender may be lowered until a selected minimum performance characteristic is achieved.

### BRIEF SUMMARY OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 is a schematic diagram of a system implementing the network device.

FIG. 2 illustrates a block diagram of a network device.

FIG. 3 illustrates a block diagram of a client device.

FIG. 4 is a flow chart illustrating a method for providing coordinated power control using a power conservation mode in a mesh network.

### DETAILED DESCRIPTION

The following detailed description is made with reference to the accompanying drawings and is provided to assist in a comprehensive understanding of various example embodiments of the present disclosure. The following description includes various details to assist in that understanding, but these are to be regarded merely as examples and not for the purpose of limiting the present disclosure as defined by the appended claims and their equivalents. The words and phrases used in the following description are merely used to enable a clear and consistent understanding of the present disclosure. In addition, descriptions of well-known structures, functions, and configurations may have been omitted for clarity and conciseness.

Aspects of the present disclosure are directed to implementation of a coordinated power control in a mesh network that uses a power conservation mode. A performance characteristic, such as received signal strength indicator (RSSI) and throughput, may be used to minimize power usage and energy radiation in a network.

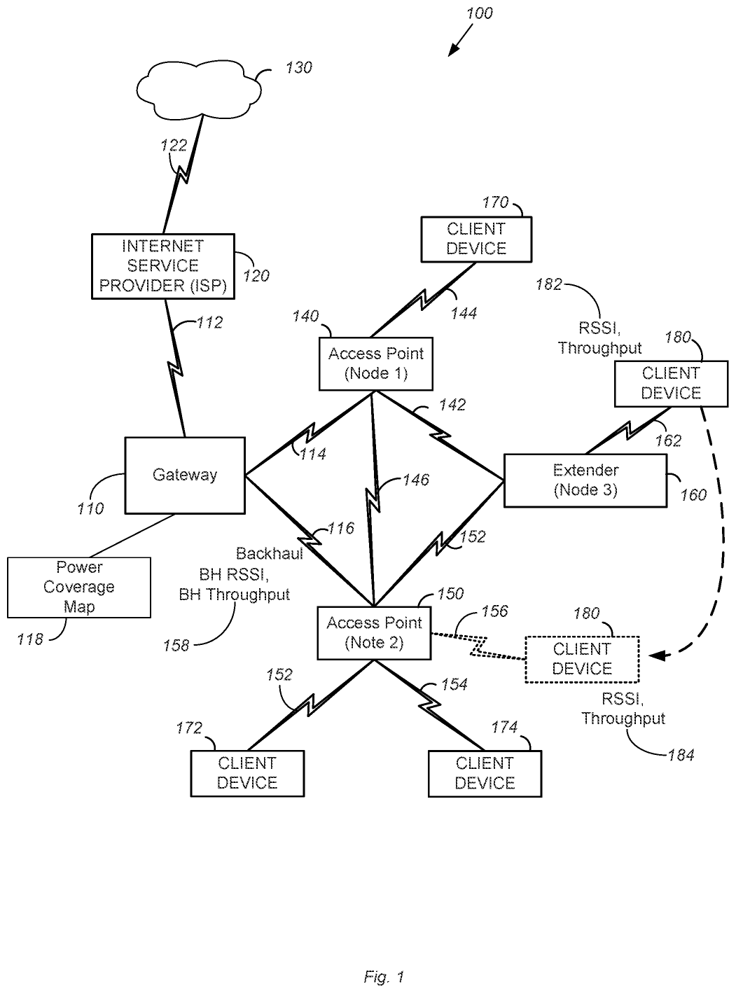

FIG. 1 is a schematic diagram of a system 100 implementing the network device.

As shown in FIG. 1, the main elements of the system include a Gateway 110 connected to an Internet Service Provider (ISP) 120 via connection 112. ISP 120 is connected to the Internet 130 via connection 122. Gateway 110 is also connected to different wireless devices, such as Access Point (node 1) 140 via connection 114, Access Point (node 2) 150 via connection 116. Extender 160 is coupled to Access Point 140 via connection 142 and to Access Point 150 via connection 152. Access Point 140 is connected to Access Point 150 via connection 146. Client Device 170 is connected to Access Point 140 via connection 144 while Client Devices 172, 174 are connected to Access Point 150 via connections 152, 154, respectively. Client Device 180 is initially connected to Extender 160 via connection 162. However, Client Device 180 device 180 may roam within the network and establishes a connection with Access Point 150. It should be understood that Client Devices 172, 174 may also roam and establish connections with Extender 160 or Access Point 140. Similarly, Client Device 170 may roam and establish a connection with Extender 160 or Access Point 150.

The wireless Client Devices 170, 172, 174, 180, and Extender 160, as shown in FIG. 1, may be connected in one or more wireless networks in system 100 (e.g., private, guest, iControl, backhaul network, or Internet of things (IoT) network). Additionally, there could be some overlap between wireless devices (e.g., wireless devices 170, 172, 174, 180, and Extender 160) in the different networks. That is, one or more network devices could be located in more than one network. For example, Extender 160 could be located both in a private network for providing content and information to Client Device 180 via connection 162 and also may be included in a backhaul network or an iControl network.

The ISP 120 can be, for example, a streaming video provider or any computer for connecting the Gateway 110 to the Internet 130. The connection 122 between the Internet 130 and the ISP 120 and the connection 112 between the ISP 120 and the Gateway 110 can be implemented using a wide area network (WAN), a virtual private network (VPN), metropolitan area networks (MANs), system area networks (SANs), a DOCSIS network, a fiber optics network (e.g., FTTH (fiber to the home) or FTTX (fiber to the x), or hybrid fiber-coaxial (HFC)), a digital subscriber line (DSL), a public switched data network (PSDN), a global Telex network, or a 2G, 3G, 4G or 5G network, for example.

Connection 112 can further include as some portion thereof a broadband mobile phone network connection, an optical network connection, or other similar connections. For example, connection 112 can also be implemented using a fixed wireless connection that operates in accordance with, but is not limited to, 3rd Generation Partnership Project (3GPP) Long Term Evolution (LTE) or 5G protocols. It is also contemplated by the present disclosure that connection 112 is capable of providing connections between the Network Device 102 and a WAN, a LAN, a VPN, MANs, PANs, WLANs, SANs, a DOCSIS network, a fiber optics network (e.g., FTTH, FTTX, or HFC), a PSDN, a global Telex network, or a 2G, 3G, 4G or 5G network, for example.

The Gateway 110 can be, for example, a hardware electronic device that may be a combination modem and gateway device that combines the functions of a modem, an Access Point, and/or a router for providing content received from the content provider (ISP) 120 to network devices (e.g., wireless Client Devices 170, 172, 174, 180, and Extender 160 in the system 100. It is also contemplated by the present disclosure that the Gateway 110 can include the function of, but is not limited to, an Internet Protocol/Quadrature Amplitude Modulator (IP/QAM) set-top box (STB) or smart media device (SMD) that is capable of decoding audio/video content, and playing over-the-top (OTT) or multiple system operator (MSO) provided content.

Connection 114 between Gateway 110 and Access Point 140, connection 116 between Gateway 110 and Access Point 150, and connections 142, 152 between Extender 160 and Access Point 140 and Access Point 150, respectively, and connection 146 between Access Point 140 and Access Point 150 can be implemented using a wireless connection in accordance with any IEEE 802.11 Wi-Fi protocols, Bluetooth protocols, Bluetooth Low Energy (BLE), or other short range protocols that operate in accordance with a wireless technology standard for exchanging data over short distances using any licensed or unlicensed band such as the citizens broadband radio service (CBRS) band, 2.4 GHz bands, 5 GHz bands, 6 GHz bands, 60 GHz bands, etc. Additionally, connections 114, 116, 142, 146, 152 can be implemented using a wireless connection that operates in accordance with, but is not limited to, RF4CE protocol, ZigBee protocol, Z-Wave protocol, or IEEE 802.15.4 protocol. It is also contemplated by the present disclosure that the connections 114, 116, 142, 146, 152 can include connections to a media over coax (MoCA) network. One or more of the connections 114, 116, 142, 146, 152 can also be a wired Ethernet connection.

The wireless Extender 160 can be, for example, hardware electronic devices such as Access Points used to extend the wireless network by receiving the signals transmitted by the Access Point 140, for example, and rebroadcasting the signals to, for example, Client Device 180, which may out of range of the Access Point 140. The wireless Extender 160 can also receive signals from the Client Device 180 and rebroadcast the signals to the Access Point 140, or Access Point 150.

The connection 162 between wireless Extender 160 and the Client Device 180 is implemented through a wireless connection that operates in accordance with any IEEE 802.11 Wi-Fi protocols, Bluetooth protocols, Bluetooth Low Energy (BLE), or other short range protocols that operate in accordance with a wireless technology standard for exchanging data over short distances using any licensed or unlicensed band such as the CBRS band, 2.4 GHz bands, 5 GHz bands, 6 GHz bands, 60 GHz bands, etc. Additionally, the connection 162 can be implemented using a wireless connection that operates in accordance with, but is not limited to, RF4CE protocol, ZigBee protocol, Z-Wave protocol, or IEEE 802.15.4 protocol. Also, connection 162 can be a wired Ethernet connection. Client Devices 170, 172, 174, 180 can be, for example, hand-held computing devices, personal computers, electronic tablets, smart phones, smart speakers, IoT devices, iControl devices, portable music players with smart capabilities capable of connecting to the Internet, cellular networks, and interconnecting with other devices via Wi-Fi and Bluetooth, or other wireless hand-held consumer electronic devices capable of executing and displaying content received through the Gateway 110. Additionally, the client devices 170, 172, 174, 180 can be a TV, an IP/QAM STB or an SMD that is capable of decoding audio/video content and playing over OTT or MSO provided content received through the gateway 110.

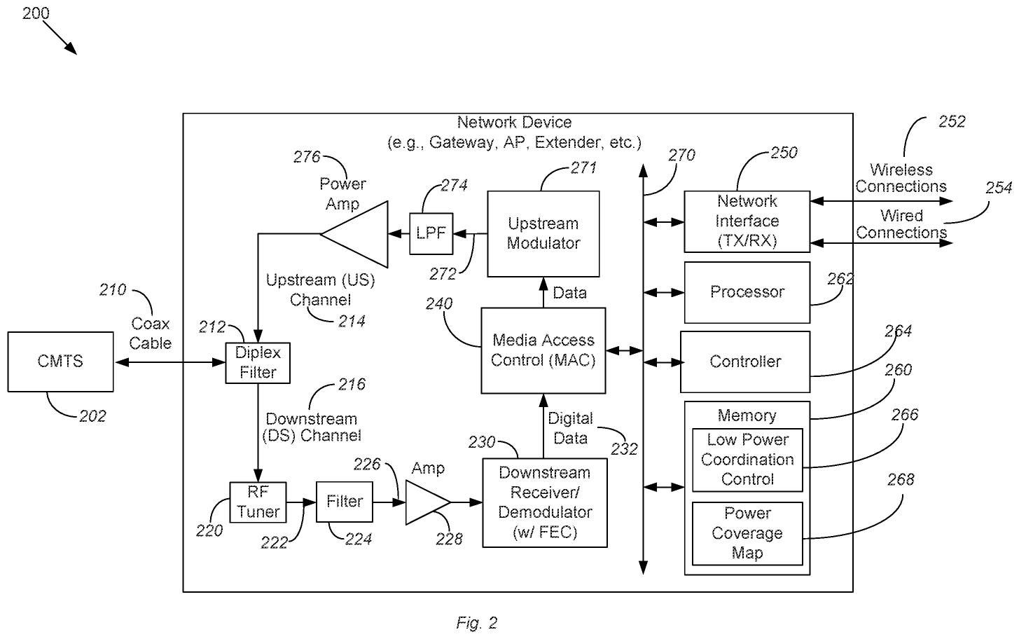

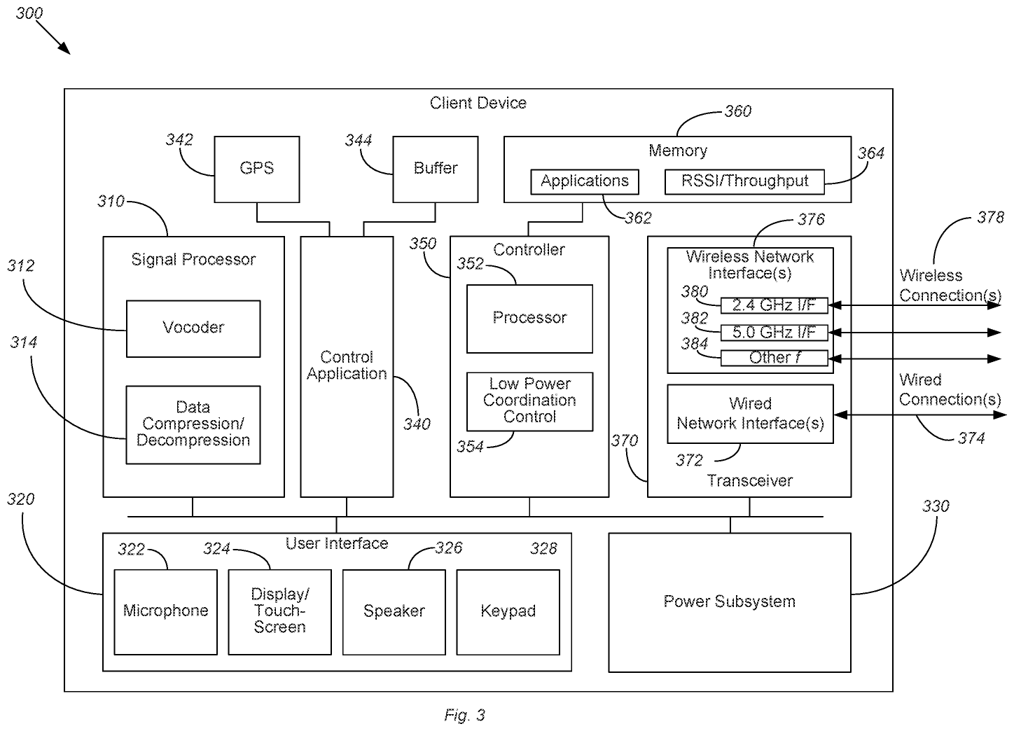

A detailed description of the exemplary internal components of the Gateway 110, Access Point 140, Access Point 150, wireless Extender 160, and Client Devices 170, 172, 174, 180, as shown in in FIG. 1, will be provided in the discussion of FIGS. 2-3. However, in general, it is contemplated by the present disclosure that the Gateway 110, Access Point 140, Access Point 150, wireless Extender 160, and Client Devices 170, 172, 174, 180, as shown in in FIG. 1, include electronic components or electronic computing devices operable to receive, transmit, process, store, and/or manage data and information associated with the system, which encompasses any suitable processing device adapted to perform computing tasks consistent with the execution of computer-readable instructions stored in a memory or a computer-readable recording medium.

Further, any, all, or some of the computing components in the Gateway 110, Access Point 140, Access Point 150, wireless Extender 160, and Client Devices 170, 172, 174, 180, as shown in in FIG. 1, may be adapted to execute any operating system, including Linux, UNIX, Windows, MacOS, DOS, and ChromOS as well as virtual machines adapted to virtualize execution of a particular operating system, including customized and proprietary operating systems. The Gateway 110, Access Point 140, Access Point 150, wireless Extender 160, and Client Devices 170, 172, 174, 180, as shown in in FIG. 1, are further equipped with components to facilitate communication with other computing devices over the one or more network connections to local and wide area networks, wireless and wired networks, public and private networks, and any other communication network enabling communication in the system.

A network controller device, such as Gateway 110, may initiate coordinated power control for a mesh network and implement a power conservation mode using the coordinated power control. A performance characteristic may be measured. The performance characteristics may be received signal strength indicator (RSSI) and throughput 182 of Client Device 180 when Client Device 180 is connected to Extender 160. A performance characteristic, e.g., RSSI and throughput 184, may be measured and maintained as Client Device 180 roams the network and disengages the connection 162 from Extender 160 and establishes a connection 156 with Access Point 150. A backhaul RSSI and throughput 158 may also be measured for an access point, such as Access Point 150.

A first command may be sent to Extender 160 or Access Point 150 to adjust a power output until the performance characteristic associated with the Extender 160 or Access Point 150 is at a selected minimum performance threshold. Extender 160 and/or Access Point 150 may have a default maximum power output setting that is established when Extender 160 or Access Point 150 are initially set up. Extender 160 and/or Access Point 150 may be restored to the default power output setting. For example, when Access Point 150 has been configured to operate in the power conservation mode, the Gateway 110 may receive a request to end the power conservation mode. Gateway 110 sends a second command to the Access Point 150 to restore power output levels to the default maximum power output setting.

Thus, the performance characteristic associated with a backhaul connection of the Access Point 150 or Extender 160, for example, may be measured and the gateway may lower a backhaul power output for the Access Point 150 or Extender 160 until a selected minimum performance characteristic for the backhaul connection is achieved. The backhaul power output may be lowered in 10% increments until the selected minimum performance characteristic for the backhaul connection is achieved. In addition, or alternatively, the performance characteristic associated with a connection of a client device, such as Client Device 180, for example, may be measured and a power output for the Access Point 150 or Extender 160 may be lowered until a selected minimum performance characteristic for the connection with Client Device 180 is achieved.

The performance characteristic associated with Client Device 180 may be monitored with respect to power output of the Access Point 150 or Extender 160 serving the Client Device 180 as Client Device 180 roams around in the network. Thus, Gateway 110 may send a command to Access Point 150 or Extender 160 to adjust the power output until the selected minimum performance threshold at the client is achieved. The monitoring the performance characteristic for Client Device 180 and adjusting the power output of different network access devices as the Client Device 180 moves in the network may be repeated to maintain the selected minimum performance threshold at the client device 180. Further, Gateway 110 may periodically, and before and after a steer of the Client Device 180 to one of the different network access devices, such as Access Point 140, Access Point 150, or Extender 160, for example, monitor the RSSI and throughput, such as RSSI and throughput 182, 184, at the Client Device 180 with respect to the one of the different network access devices serving the client so as to maintain the RSSI and throughput 182, 184 at a predetermined performance threshold.

FIG. 2 illustrates a block diagram of a network device 200.

In FIG. 2, network device 200 may be coupled to a cable modem termination system (CMTS) 202 by a cable 210, for example, a coaxial cable. A diplex filter 212 may be used to separate the upstream channel signals 214 and the downstream channel signals 216. An RF tuner 220 receives an incoming signal received from the CMTS 202 on a downstream channel 216 via the cable 210 while outgoing data is directed to the CMTS 202 on an upstream channel 214. The RF tuner 220 converts the RF signal from the downstream channel 216 to IF signals 222 and outputs the IF signals 222 to a filter 224, such as a surface acoustic wave (SAW) filter, where the signal is filtered and limited to a predetermined bandwidth, e.g., a 6 MHz bandwidth. The filtered signal 226 is passed through an amplifier 228 to a receiver/demodulator 230, where an analog-to-digital (or “A/D”) conversion of the signal, followed by a QAM demodulation, Viterbi decoding and forward error correction (FEC) of the filtered signal 226 may also be performed to produce a digital signal 232. The digital signal 232 is then transmitted to a media access controller (or “MAC”) 240 which controls the protocol and administration layer of the network device 200. The MAC 240, which may be implemented in either hardware or a combination of hardware and software, assigns frequencies and data rates for upstream transmissions and allocates time slots for upstream transmission. From the MAC 240, data continues on to a network interface 250.

In addition to being part of the downstream path from a CMTS 202, the MAC 240 is also in the upstream path and extends to the upstream channel 214. Digital data received at the network interface 250, or stored in memory 260, may be transferred to MAC 240. From the MAC 240, the digital data is passed on to the modulator 271. There, the digital data is modulated onto a selected frequency and converted into an analog signal 272. From the modulator 271, the analog signal 272 is transmitted to a low pass filter 274, and a power amplifier 276 to produce a signal on the upstream channel 214. The signal on the upstream channel 214 enters the diplex filter 212. The diplex filter 212 directs the signal on the upstream channel 214 onto the cable 210 for transmission to the CMTS 202.

Network device 200 also includes memory, processor 262, and controller 264. Memory 260 may include low power coordination control 266 and power coverage map 268. The processor 262, controller 264, network interface 250, and memory 260 are coupled to MAC 240 by a bus 270. The controller 264 controls operation of the network device 200, including band selection and tuning, for example, using information residing in the memory 260, such as low power coordination control 266 and power coverage map 268, which are used to implement a power conservation mode by measuring RSSI and throughput of client devices and/or network devices. Network device 200 includes network interfaces 250 for communicating with other devices such as a client device 108 as shown in FIG. 1. Network interfaces 250 may provide wireless connections 252 and/or wired connections 254.

Controller 264 may direct communication using wireless connections 252 and/or wired connections 254. Again as described above, communication between a client device and the network interface 250 of network device 200 may be by a wireless connection 252 in accordance with Bluetooth protocols, Bluetooth Low Energy (BLE), or other short range protocols that operate in accordance with a wireless technology standard for exchanging data over short distances using any licensed or unlicensed band such as the CBRS band, 2.4 GHz bands, 5 GHz bands, 6 GHz bands, or 60 GHz bands, or may be by a wired connection 254, such as an Ethernet connection. Multiple interfaces may be provided by network interfaces 250 for communication using wireless connections 252 and/or wired connections 254. Low power coordination control 266 and power coverage map 268 are used to implement a power conservation mode by measuring RSSI and throughput of client devices and/or network devices. The network device 200 uses the network interfaces 250 for communication of data via wireless connections 252 or wired connections 254.

The network device 200, such as s gateway, may initiate coordinated power control for a mesh network and implement a power conservation mode using the coordinated power control. Network device 200 measures a performance characteristic via low power coordination control 266. The performance characteristics may be received signal strength indicator (RSSI) and throughput of client device provided to the network device 200 via wireless connections 252 or wired connections 254 of network interface 250. Network device 200 may also measure a backhaul RSSI and throughput from access points and/or extenders.

Network device 200 may use the low power coordination control 266 to send a command via wireless connections 252 or wired connections 254 of network interface 250 to extenders or access points to adjust a power output until the performance characteristic associated with the extender or access point is at a selected minimum performance threshold. An access point and/or extender has a default maximum power output setting that is established when the access point is initially set up. When the access point or extender has been configured to operate in the power conservation mode, the network device may receive a request to end the power conservation mode and can send another command to the access point or extender to restore power output levels to the default maximum power output setting.

Thus, the performance characteristic associated with a backhaul connection of the access point or extender at network interface 250 may be measured and the network device may use the low power coordination control to lower the backhaul power output for the access point or extender until a selected minimum performance characteristic for the backhaul connection is achieved. The backhaul power output may be lowered in 10% increments until the selected minimum performance characteristic for the backhaul connection is achieved. In addition, or alternatively, the performance characteristic associated with a connection of a client device in a network that the network device 200 is associated with may be measured and a power output for the access point or extender may be commanded to be lowered until a selected minimum performance characteristic for the connection with client device is achieved.

The low power coordination control 266 of the network device 200 may monitor a performance characteristic associated with a client device as the client device roams around in the network. Thus, low power coordination control 266 of the network device 200 may send a command to an access point or extender connected to a client device to adjust the power output until the selected minimum performance threshold at the client device is achieved.

FIG. 3 illustrates a block diagram of a client device 300.

In FIG. 3, client device 300 includes a signal processor 310. Signal processor 310 may include a vocoder 312 that analyzes and processes voice signals. Data compression/decompression 314 provides computational resources for encoding signals prior to transmission and decoding signals that are received by the client device 300. Client device 300 includes user interfaces 320, such as microphone 322, display/touch screen 324, speaker 326, and keypad 328. A power subsystem 330 may provide power to the client device 300. Power subsystem 330 may include a power supply with an input to be coupled to AC power source and a DC power source. DC Power may be used whenever client device 300 is connected to power supply and DC power may be provided as long as a battery has charge.

A control application 340 is provided to configure, monitor, and control one or more features of client device 300, such as coordinated power control for a network device that is implement via low power coordination control 354 under direction of process 352 or controller 350. Control application 340 may also be coupled to a Global Positioning System (GPS) receiver 342 to provide location data for processing. Buffer 344 may buffer data used by control application 340. Other applications may be provided, such as applications 352 maintained in memory 352. Processor 360 is coupled to memory 350. Processor 360 implements low power coordination control 354, which coordinates the measurement and maintenance of a performance characteristic e.g., a received signal strength indicator (RSSI) and throughput of the client device 300.

A transceiver 370 provides for transmitting and receiving communication signals. Transceiver 370 includes wired network interfaces 372 for wired connections 374. For example, wired network interfaces 372 may provide wired connections 374, such as Ethernet connections. Transceiver 370 may also include wireless network interfaces 376 for supporting wireless connections 378. Wireless network interfaces 376 includes a first interface 380 configured to provide a first type of Internet Protocol (IP) connection, such as a 2.4 GHz Wi-Fi connection. Wireless network interfaces 376 also includes a second interface 382 configured to provide a second type of IP connection, such as a 5.0 GHz connection. Wireless network interfaces 376 may also provide additional available wireless interfaces 384, such as 6 GHz, 60 GHz, etc.

Client device 300 may be controlled by a network controller device, such as a gateway, which may initiate the low power coordination control 354 that implements a power conservation mode. A performance characteristic of the client device 300 may be measured. The performance characteristics may be received signal strength indicator (RSSI) and throughput 364 of client device 300 when client device 300 is connected to an Access Point or an Extender. A performance characteristic, e.g., RSSI and throughput 364, may be measured and maintained in memory 360 as client device 300 roams the network.

Low power coordination control 354 may send a command to an extender or an access point to adjust a power output until the performance characteristic, such as RSSI and throughput 364 associated with the extender or access point as measured at the client device 300 is at a selected minimum performance threshold. An access point has a default maximum power output setting that is established when the access point is initially set up. When access point or extender has been configured to operate in the power conservation mode, the low power coordination control 354 may restore power output levels to the default maximum power output setting.

Thus, the performance characteristic associated with an access point or extender may be measured and the power output for the access point or extender may be lowered until a selected minimum performance characteristic for the client device 300 is achieved. The power output may be lowered in 10% increments until the selected minimum performance characteristic for the client device 300 is achieved.

The performance characteristic associated with client device 300 may be monitored with respect to power output of the access point or extender serving the client device 300 as the client device 300 roams around in the network. Thus, the low power coordination control 354 adjust the power output of an access point or extender until the selected minimum performance threshold at the client device 300 is achieved. The monitoring the performance characteristic for client device 300 and adjusting the power output of different network access devices as the client device 300 moves in the network may be repeated to maintain the selected minimum performance threshold at the client device 300.

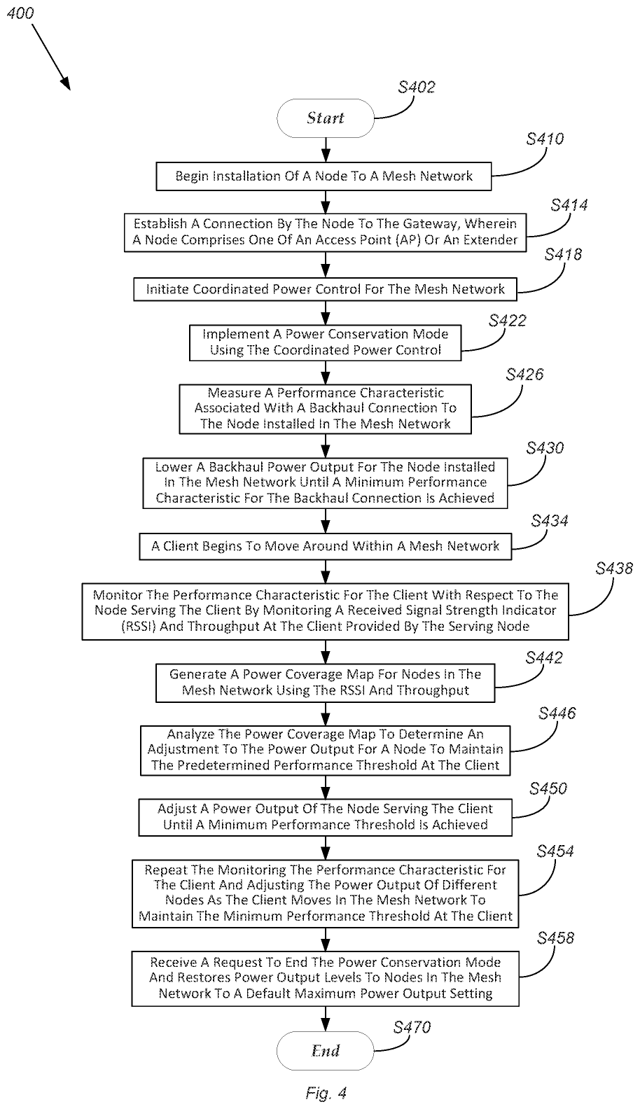

FIG. 4 is a flow chart 400 illustrating a method for providing coordinated power control using a power conservation mode in a mesh network. A performance characteristic, such as received signal strength indicator (RSSI) and throughput, may be used to minimize power usage and energy radiation in a network is minimized based on lowering a measured performance characteristic and maintaining the lower performance characteristic as a client device roams the network.

In FIG. 4, method 400 starts (S402), and a node to a mesh network is installed (S410). A connection by the node to the gateway is established, wherein a node comprises one of an access point (AP) or an extender (S414). Coordinated power control for the mesh network is initiated (S418). A power conservation mode is implemented using the coordinated power control (S422). A performance characteristic associated with a backhaul connection to the node installed in the mesh network is measured (S426). A network controller device, such as Gateway 110, may initiate coordinated power control for a mesh network and implement a power conservation mode using the coordinated power control.

A backhaul power output for the node installed in the mesh network is lowered until a minimum performance characteristic for the backhaul connection is achieved (S430). The performance characteristic associated with a backhaul connection of the Access Point 150 or Extender 160, for example, may be measured and the gateway may lower a backhaul power output for the Access Point 150 or Extender 160 until a selected minimum performance characteristic for the backhaul connection is achieved. The backhaul power output may be lowered in 10% increments until the selected minimum performance characteristic for the backhaul connection is achieved.

A client begins to move around within a mesh network (S434). The performance characteristic associated with client device 180 may be monitored with respect to power output of the Access Point 150 or Extender 160 serving the client device 180 as client device 180 roams around in the network.

The performance characteristic is monitored for the client with respect to the node serving the client by monitoring a received signal strength indicator (RSSI) and throughput at the client provided by the serving node (S438). The performance characteristic associated with a connection of a client device, such as client device 180, for example, may be measured and a power output for the Access Point 150 or Extender 160 may be lowered until a selected minimum performance characteristic for the connection with client device 180 is achieved.

A power coverage map is generated for nodes in the mesh network using the RSSI and throughput (S442). Gateway 110 may periodically, and before and after a steer of the client device 180 to one of the different network access devices, such as Access Point 140, Access Point 150, or Extender 160, for example, monitor the RSSI and throughput at the client device 180 with respect to the one of the different network access devices serving the client so as to maintain the RSSI and throughput at a predetermined performance threshold.

The power coverage map is analyzed to determine an adjustment to the power output for a node to maintain the predetermined performance threshold at the client (S446). A first command may be sent to Extender 160 or Access Point 150 to adjust a power output until the performance characteristic associated with the Extender 160 or Access Point 150 is at a selected minimum performance threshold.

A power output of the node serving the client is adjusted until a minimum performance threshold is achieved (S450). Gateway 110 may send a command to Access Point 150 or Extender 160 to adjust the power output until the selected minimum performance threshold at the client is achieved.

The monitoring the performance characteristic for the client is repeated and the power output of different nodes is adjusted as the client moves in the mesh network to maintain the minimum performance threshold at the client (S454). The monitoring the performance characteristic for client device 180 and adjusting the power output of different network access devices as the client device 180 moves in the network may be repeated to maintain the selected minimum performance threshold at the client device 180.

A request to end the power conservation mode is received and power output levels to nodes in the mesh network are restored to a default maximum power output setting (S458). An access point, such as Access Point 150, has a default maximum power output setting that is established when Access Point 150 is initially set up. When Access Point 150 has been configured to operate in the power conservation mode, the Gateway 110 may receive a request to end the power conservation mode and can send a second command to the Access Point 150 to restore power output levels to the default maximum power output setting. The method then ends (S7702).

The processes discussed in this disclosure may be implemented in hardware, software, or a combination thereof. In the context of software, the described operations represent computer-executable instructions stored on one or more non-transitory computer readable recording medium that, when executed by one or more hardware processors, perform the recited operations. Generally, computer-executable instructions include routines, programs, objects, components, data structures, and the like that perform particular functions or implement particular abstract data types. Those having ordinary skill in the art will readily recognize that certain steps or operations illustrated in the figures above may be eliminated, combined, or performed in an alternate order. Any steps or operations may be performed serially or in parallel. Furthermore, the order in which the operations are described is not intended to be construed as a limitation.

Subject matter of the present disclosure may be provided as a computer program product including one or more non-transitory computer readable recording medium having stored thereon instructions (in compressed or uncompressed form) that may be used to program a computer (or other electronic device) to perform processes or methods described herein. The computer-readable storage media may include one or more of an electronic storage medium, a magnetic storage medium, an optical storage medium, a quantum storage medium, or the like. For example, the computer-readable storage media may include, but are not limited to, hard drives, floppy diskettes, optical disks, read-only memories (ROMs), random access memories (RAMs), erasable programmable ROMs (EPROMs), electrically erasable programmable ROMs (EEPROMs), flash memory, magnetic or optical cards, solid-state memory devices, or other types of physical media suitable for storing electronic instructions. Further, subject matter of the present disclosure may also be provided as a computer program product including a transitory machine-readable signal (in compressed or uncompressed form). Examples of machine-readable signals, whether modulated using a carrier or unmodulated, include, but are not limited to, signals that a computer system or machine hosting or running a computer program may be configured to access, including signals transferred by one or more networks. For example, a transitory machine-readable signal may comprise transmission of software by the Internet. Separate instances of these programs can be executed on or distributed across any number of separate computer systems. Thus, although certain steps have been described as being performed by certain devices, software programs, processes, or entities, this need not be the case. A variety of alternative implementations will be understood by those having ordinary skill in the art.

Use of the phrases “capable of,” “capable to,” “operable to,” or “configured to”, refers to some apparatus, logic, hardware, and/or element designed in such a way to enable use of the apparatus, logic, hardware, and/or element in a specified manner. The subject matter of the present disclosure is provided as examples of apparatus, systems, methods, and programs for performing the features described in the present disclosure. However, further features or variations are contemplated in addition to the features described above. It is contemplated that the implementation of the components and functions of the present disclosure can be done with any newly arising technology that may replace any of the above implemented technologies.

Additionally, those having ordinary skill in the art readily recognize that the techniques described above can be utilized in a variety of devices, environments, and situations. Although the subject matter has been described in language specific to structural features or methodological acts, it is to be understood that the subject matter defined in the appended claims is not necessarily limited to the specific features or acts described. Rather, the specific features and acts are disclosed as exemplary forms of implementing the claims.

What is claimed is:

1. A network controller device, comprising:
a memory storing computer-readable instructions; and
a processor configured to execute the computer-readable instructions to:
initiate coordinated power control for a mesh network;
implement a power conservation mode using the coordinated power control;
measure a performance characteristic associated with a network device in the mesh network; and
send a first command to the network device to adjust a power output of the network device until the performance characteristic associated with the network device is at a selected minimum performance threshold.

2. The network controller device of claim 1, wherein the network device has a default maximum power output setting, and wherein the processor receives a request to end the power conservation mode and sends a second command to the network device to restore power output levels of the network device in the mesh network to the default maximum power output setting.

3. The network controller device of claim 1, wherein the network device comprises a network access device comprising one of an access point or an extender and wherein the performance characteristic comprises the power output of the one of the access point or the extender, wherein, during installation of the one of the access point or the extender in the mesh network, the processor is further configured to:
establish a connection with the one of the access point or the extender;
measure the performance characteristic associated with a backhaul connection of the one of the access point or the extender installed in the mesh network; and
send an instruction to the one of the access point or the extender to lower a backhaul power output for the one of the access point or the extender installed in the mesh network until a selected minimum performance characteristic for the backhaul connection is achieved.

4. The network controller device of claim, 3 wherein the connection comprises one of Wi-Fi connection or an Ethernet connection.

5. The network controller device of claim 3, wherein the processor measures the performance characteristic associated with the backhaul connection to the one of the access point or the extender by measuring a backhaul received signal strength indicator (RSSI) and throughput, wherein the instruction sent to the one of the access point or the extender to lower the backhaul power output of the one of the access point or the extender comprises an instruction to lower the backhaul power output of the one of the access point or the extender in increments until the backhaul received signal strength indicator (RSSI) and throughput are at a predetermined performance threshold.

6. The network controller device of claim 3, wherein the processor commands the network device to lower the backhaul power output in 10% increments.

7. The network controller device of claim 1, wherein the network device comprises a client and wherein the performance characteristic associated with the client is based on the power output of a network access device comprising one of an access point or an extender coupled to the client, wherein, as the client moves around in the mesh network, the processor is further configured to:
monitor the performance characteristic for the client with respect to the network access device serving the client;
send a second command to the one of the access point or the extender to adjust the power output of the one of the access point or the extender having a connection with the client until the selected minimum performance threshold at the client is achieved; and
repeat the monitoring the performance characteristic for the client and sending the second command to adjust the power output of different network access devices as the client moves in the mesh network and establishes a connection with one of different network access devices, the second command to adjust the power output of the different network access devices maintains the selected minimum performance threshold at the client.

8. The network controller device of claim 7, wherein the processor, periodically, and before and after a steer of the client to one of the different network access devices, monitors a received signal strength indicator (RSSI) and throughput at the client with respect to the one of the different network access devices serving the client and maintains the RSSI and throughput at a predetermined performance threshold.

9. A method for providing a low power mesh network, comprising:
initiating coordinated power control for a mesh network;
implementing a power conservation mode using the coordinated power control;
measuring a performance characteristic associated with a network device in the mesh network; and
sending a first command to the network device to adjust a power output of the network device until the performance characteristic associated with the network device is at a selected minimum performance threshold.

10. The method of claim 9 further comprising receiving a request to end the power conservation mode and sending to the network device a second command to restore power output levels of the network device in the mesh network to a default maximum power output setting.

11. The method of claim 9, wherein the network device comprises a network access device comprising one of an access point or an extender and wherein the performance characteristic comprises the power output of the one of the access point or the extender, wherein, during installation of the one of the access point or the extender in the mesh network, the method further comprising:
establishing a connection by the one of the access point or the extender to a gateway;
measuring the performance characteristic associated with a backhaul connection of the one of the access point or the extender installed in the mesh network; and
sending an instruction to the one of the access point or the extender to lower a backhaul power output for the one of the access point or the extender installed in the mesh network until a selected minimum performance characteristic for the backhaul connection is achieved.

12. The method of claim 11, wherein the measuring the performance characteristic associated with the backhaul connection to the one of the access point or the extender further comprises measuring a backhaul received signal strength indicator (RSSI) and throughput, and the sending the first command to lower the backhaul power output further comprises sending the first command to the one of the access point or the extender to lower the backhaul power output in increments until the backhaul RSSI and throughput are at a predetermined performance threshold.

13. The method of claim 9, wherein the network device comprises a client and wherein the performance characteristic associated with the client is based on the power output of a network device, the network access device comprising one of an access point or an extender coupled to the client, wherein, as the client moves around in the mesh network, the method further comprising:
monitoring the performance characteristic for the client with respect to the network access device serving the client;
sending a second command to the network access device to lower the power output of the network access device having a connection with the client until the selected minimum performance threshold at the client is achieved;
repeating the monitoring the performance characteristic for the client and sending the second command to lower a power output of different network access devices as the client moves in the mesh network; and
establishing a connection with one of the different network devices, the sending the second command to lower the power output of the different network devices maintaining the minimum performance threshold at the client.

14. The method of claim 13 further comprising, periodically, and before and after a steer of the client to one of the different network access devices, monitoring the received signal strength indicator (RSSI) and throughput at the client with respect to the one of the different network access devices serving the client, and maintaining the RSSI and throughput at a predetermined performance threshold at the client.

15. A non-transitory computer-readable media having computer-readable instructions stored thereon, which when executed by a processor causes the processor to perform operations comprising:
initiating coordinated power control for a mesh network;
implementing a power conservation mode using the coordinated power control;
measuring a performance characteristic associated with a network device in the mesh network; and
sending a first command to the network device to adjust a power output of the network device until the performance characteristic associated with the network device is at a selected minimum performance threshold.

16. The non-transitory computer-readable media of claim 15 further comprising receiving a request to end the power conservation mode and sending to the network device a second command to restore power output levels of the network device in the mesh network to a default maximum power output setting.

17. The non-transitory computer-readable media of claim 15, wherein the network device comprises a network access device comprising one of an access point or an extender and wherein the performance characteristic comprises the power output of the one of the access point or the extender, wherein, during installation of the one of the access point or the extender, the operations further comprising:
establishing a connection by the one of the access point or the extender to a gateway;
measuring the performance characteristic associated with a backhaul connection of the one of the access point or the extender installed in the mesh network; and
sending an instruction to the one of the access point or the extender to lower a backhaul power output for the one of the access point or the extender installed in the mesh network until a selected minimum performance characteristic for the backhaul connection is achieved.

18. The non-transitory computer-readable media of claim 17, wherein the measuring the performance characteristic associated with the backhaul connection to the one of the access point or the extender further comprises measuring a backhaul received signal strength indicator (RSSI) and throughput, and the sending the first command to lower the backhaul power output further comprises sending the first command to the one of the access point or the extender to lower the backhaul power output in increments until the backhaul RSSI and throughput are at a predetermined performance threshold.

19. The non-transitory computer-readable media of claim 15, wherein the network device comprises a client and wherein the performance characteristic associated with the client is based on the power output of a network access device, the network access device comprising one of an access point or an extender, wherein, as the client moves around in the mesh network, the operations further comprising: power output
monitoring the performance characteristic for the client with respect to the network access device serving the client;
sending a second command to the network access device to lower the power output of the network access device having a connection with the client until the selected minimum performance threshold at the client is achieved;
repeating the monitoring the performance characteristic for the client and sending the second command to lower a power output of different network access devices as the client moves in the mesh network; and
establishing a connection with one of the different network access devices, the sending the second command to lower the power output of the different network access devices maintaining the minimum performance threshold at the client.

20. The non-transitory computer-readable media of claim 19 further comprising, periodically, and before and after a steer of the client to one of the different network access devices, monitoring the received signal strength indicator (RSSI) and throughput at the client with respect to the one of the different network access devices serving the client, and maintaining the RSSI and throughput at a predetermined performance threshold at the client.
